(19) United States
(12) Patent Application Publication
(10) Pub. No.: US 2010/0045875 A1
(43) Pub. Date: Feb. 25, 2010

(54) ADAPTIVE TUNER

(75) Inventor: Michael Anthony Pugel, Noblesville, IN (US)

Correspondence Address: Robert D. Shedd, Patent Operations;THOMSON Licensing LLC, P.O. Box 5312, Princeton, NJ, 08543-5312, US

(73) Assignee: Thomson Licensing LLC, Princeton, NJ (US)

(21) Appl. No.: 12/312,661

(22) PCT Filed: Dec. 4, 2006
(86) PCT No.: PCT/US2006/046230

§ 371 Date: May 20, 2009

(51) Int. Cl. H04N 5/50

(52) U.S. Cl. 348/731; 348/E05.097

(57) ABSTRACT

A signal tuning system including a picture-in-picture (PIP) feature includes a first and a second tuner. The first and second tuners are adapted to tune to a first and a second channel of a received signal in response to a state of the received signal. A switching device coupled to the tuners switches the tuner carrying a primary channel to a primary display area. The switching device also switches the other tuner carrying the secondary channel to a PIP display in a PIP display area. One tuner is a higher performance tuner and the other a lower performance tuner. Therefore the more sensitive tuner is tuned to the weaker one of the two received channels.

### FIELD OF THE INVENTION

The present invention relates to tuning devices and more particularly to signal distribution within tuning devices.

### BACKGROUND

Radio-frequency (RF) communication has become ubiquitous in recent years, and the many sources of RF signals have created a congested signal environment in many areas of the United States and abroad. Simultaneously, the advent of digital communications technologies has imposed stringent requirements on characteristics of the received signal, such as noise, sensitivity, and dynamic range. Analog signals tend to degrade more gracefully then digital signals which can fall off abruptly. Therefore, digital television is one digital communications technology likely to require specific signal characteristics at the receiver.

As digital television increases in popularity, users are likely to demand improvements in performance and convenience to accompany the significant investment required to switch from analog to digital television equipment. For example, users are likely to expect reception of television signals virtually free from interference in addition to convenient integration of additional components such as set top box (STB) devices, personal video recorders (PVR), high-definition (HD) receivers, etc.

It is well-known to communicate multiple information signals concurrently by frequency division multiplexing. For example, a coaxial cable is conventionally used to carry hundreds of television channels simultaneously. Also, a single terrestrial antenna can receive a plurality of signals at one time. The plurality of signals can originate from a common source, or from multiple geographically separated sources.

Consumer demand has led to broadening functionality, and increasing sophistication, of television receiving devices. For example, receiving devices are now available that can record an incoming television channel while simultaneously displaying a second incoming television channel, both of the television channels being extracted from a common received RF signal.

It is also known to receive and record multiple television channels simultaneously, and to display multiple television channels simultaneously. For example, some consumer televisions now include picture in picture (PIP) functionality. PIP functionality allows a display of a first video signal on a first region of a video display screen while simultaneously displaying a second video signal on a second smaller region within the first region of the screen.

In implementing these convenient functions, it is known to use multiple tuner devices within a single receiving system. For example, a first tuner device can be used to extract a main signal from an RF carrier signal. An output video signal of the first tuner device is, for example, used to create a first main display on a video display screen of a PIP system. A second tuner device is used to extract a PIP image signal from the RF carrier signal. An output video signal of the second tuner device is used to create a second PIP display on a sub-region of the video display screen of the PIP system.

In order to implement a multi-channel functionality such as, for example, PIP video display functionality and/or simultaneous multi-channel recording, with multiple tuners, each tuner must receive a portion of the incoming carrier signal. In a conventional tuner system, the division of the incoming signal into respective portions for each tuner is generally achieved with a signal splitter.

A signal splitter is a device that receives a signal at an input port, and produces an output signal at two or more output ports. The output signal produced at each of the two or more outputs has substantially the same frequency content as the input signal received at the input of the signal splitter. Dividing the input signal between two outputs of a passive signal splitter device results in a corresponding division of signal power. Thus, for a passive signal splitter device, the aggregate output power of the output signals is no more than the power of the input signal. Each output signal contains only a portion, or share, of the power of the original input signal.

In an exemplary PIP receiving system an incoming signal carrying multiple channels is split by a splitter device. A first output of the splitter device is coupled to an input of a first tuner and a second output of the splitter device is coupled to an input of a second tuner. The first tuner tunes, for example, the video signal for the main channel while the second tuner carries the signal for the second channel. If the signal is distributed equally on the two paths, both signals degrade approximately equally when PIP is used as compared with the signal quality of the primary path when PIP is not used.

Because a main image is larger than a PIP image, a defect in an image that is displayed in the main image region of a display screen tends to be more apparent to a viewer than a comparable defect in an image that is displayed in the PIP image region. Some systems are thus arranged to provide a stronger image signal to the device generating the main image as compared to the image signal provided to the device generating the PIP image. In such a system, the incoming signal may be split unequally at the splitter device and/or one tuner may have better sensitivity than the other tuner.

In a system where one tuner is a higher performance tuner and the other a lower performance tuner, the path having the higher performance tuner is referred to as a high performance path and the path having the other tuner is referred to as a low performance path. Typically, the high performance path carries the main channel and the low performance path carries the PIP channel. Consequently, in ordinary circumstances, the image presented in the main region has a higher absolute quality than the image presented in the PIP region, compensating for the above-noted increased visibility of defects present in the main region.

In a case where the signal quality of the PIP channel is particularly weak, however, it follows that the PIP display is poorer than the main display because the signal is delivered over the low performance path. If, at the same time, the main channel signal is strong, then using the high performance path to carry the main channel adds little to the display quality of the main channel. Accordingly, it is desirable to provide a mechanism to route signals based on signal reception and signal path characteristics.

### SUMMARY OF THE INVENTION

The present invention relates to a system, method and apparatus for distributing signals within a multi-signal tuning system. According to various embodiments of the invention a selection of signal paths and devices is selected to provide optimal output signal quality depending on the quality of an input signal received. In one embodiment, the invention is directed to a signal tuning system having two tuner devices such as a picture in a picture (PIP) tuning system. Each of the tuning devices is adapted to be tuned to a variety of channels including a first channel of a received signal, corresponding to a main image, and a second channel of the received signal, corresponding to a PIP image. In one embodiment of the invention, the two tuners have different signal tuning characteristics. For example, in one embodiment of the invention, one tuner is more sensitive than the other tuner.

According to one embodiment of the invention, the channel to which each tuner is tuned is based, at least in part, on a reception characteristic of the received signal. For example, in one embodiment of the invention, the more sensitive tuner is adapted to be tuned to the substantially weaker one of two received channels. Further embodiments of the invention include signal tuning devices that are adapted to operate where there is an unequal input signal split between the tuners or where the tuners have different characteristics.

The present invention is directed to a method and apparatus for receiving a modulated RF input signal at a receiving system and recovering and routing signals contained therein for optimal information recovery. In various embodiments, the present invention includes controlling a multi-tuner system to select an optimal tuner to receive a particular information channel, and directing an output of the selected tuner to, for example, a display device.

In one embodiment, the invention includes a signal tuning device for use in a system such as a video display system having a PIP feature. The signal tuning device has two tuners where the first tuner is adapted to tune to a first channel and a second tuner is adapted to tune to a second channel of a received signal. A switching device coupled to the tuners switches the tuners such that the tuner carrying a main channel is coupled to a main display unit and the tuner carrying a secondary channel is coupled to a PIP display unit.

According to one embodiment of the invention, a signal tuning device includes a first more sensitive tuner and a second less sensitive tuner. The signal tuning device further includes a controller. The controller is adapted to tune the first and the second tuners to respective first and second channels of a received signal.

According to a first operational state of the controller, the controller tunes the first tuner to a primary channel and the second tuner to a secondary channel. In a further aspect of the invention, the controller directs a primary channel output of the first tuner to a main decoder and a secondary channel output of the second tuner to a PIP decoder. In this way the first tuner provides primary channel output to the main decoder and the second tuner provides secondary channel output to the PIP decoder.

In a second operational state of the controller, the controller tunes the first tuner to the secondary channel and the second tuner to the primary channel. In a further aspect of the invention, the controller directs the secondary channel output of the first tuner to the PIP decoder and the primary channel output of the second tuner to the main decoder. In this way the first tuner provides secondary channel output to the PIP decoder and the second tuner provides primary channel output to the main decoder. By controlling signal paths in relation to operational states, the system produces a superior combination of main image quality and PIP image quality when the signal of the secondary channel would otherwise be inadequate to provide an optimal PIP image.

The term “decoder” is used throughout this application for simplicity. One of skill in the art will appreciate that, in some receiving systems, an alternative signal processing device is used in place of a decoder. For example, in an analog television system, the respective outputs of the first and second tuners are provided to respective amplifiers and/or display devices.

According to one embodiment of the invention, the signal splitting device is adapted to provide different first and second signal power levels at the respective inputs of the first and second tuners. That is, the signal splitting device splits the incoming signal unequally. In one embodiment of the invention, the output of the signal splitting device is amplified by the signal splitting device. In one embodiment of the invention the signal splitter is adapted to be bypassed, when PIP functionality is disabled.

According to one aspect of the invention, the signal tuning device includes a switching device. In various embodiments, the switching device is an electronic switching device such as a transistor switching device, an electro-optical switching device or an electromechanical switching device, for example.

In one embodiment of the invention, the signal tuning device includes a display screen where the display screen is adapted to substantially concurrently receive respective signals from the first and second display devices. In this way, respective channels may be substantially concurrently viewed on the display screen.

The present invention is directed to a signal tuning device for use in a system such as, for example, a video display system having a picture-in-picture (PIP) feature. In one embodiment, the signal tuning device has two tuners. Each of the tuners is adapted to be tuned to a variety of channels including a first channel of a received signal, corresponding to a main image, and a second channel of the received signal, corresponding to a PIP image. In one embodiment of the invention, the two tuners have different signal tuning characteristics. For example, in one embodiment of the invention, one tuner exhibits better sensitivity than the other tuner.

According to one embodiment of the invention, the channel to which each tuner is tuned is based, at least in part, on a reception characteristic of an input signal as received at the tuner. For example, in one embodiment of the invention, a tuner having better sensitivity is adapted to be tuned to the substantially weaker one of two received channels. Further embodiments of the invention include signal tuning devices that are adapted to operate where there is an unequal input signal split between the tuners or where the tuners have different characteristics.

The terms “signal” and “signals” used herein are understood to include analog and/or digital signals, at a single frequency or a plurality of frequencies, and may further include coding, modulation, sideband information, and other features of signals and waveforms as known in the art.

The present invention together with the above and other advantages may best be understood from the following detailed description of the embodiments of the invention illustrated in the drawings, wherein:

### BRIEF DESCRIPTION OF THE DRAWINGS

FIG. 1 shows, in block diagram form, a signal tuning device according to a first embodiment of the invention;

FIG. 2 shows, in block diagram form, a signal tuning device according to a second embodiment of the invention;

FIG. 3 shows, in flowchart form, the routing of signals in a signal tuning device according to one embodiment of the invention;

FIG. 4 shows, in block diagram form, a tuning system according to another embodiment of the invention; and

FIG. 5 shows, in block diagram form, a tuning system according to a further embodiment of the invention.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized, and that structural, logical and electrical changes may be made without departing from the spirit and scope of the present invention.

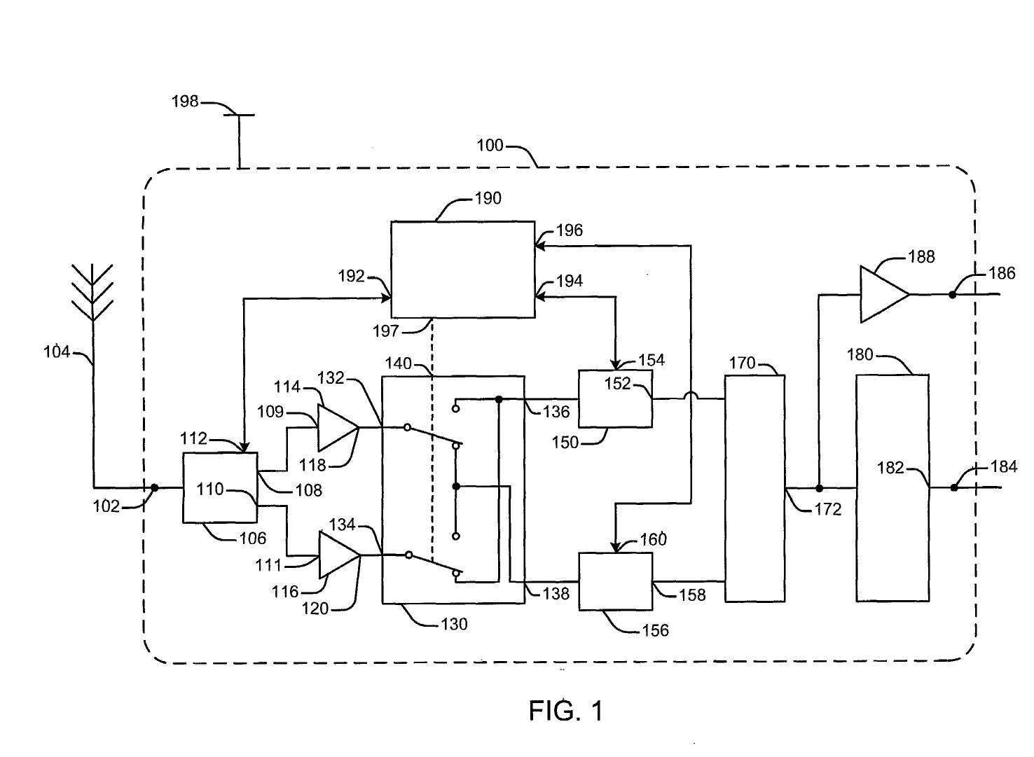

FIG. 1 shows in block diagram form, a signal tuning system 100 according to one embodiment of the invention. The signal tuning system is adapted to receive a modulated signal, such as a modulated RF signal, at an input node 102. In the illustrated embodiment, the input node 102 is coupled to a terrestrial antenna 104 to receive such a modulated signal. Also coupled to input node 102 is a signal input of a splitter device 106, such as the exemplary splitter device described above.

In the illustrated embodiment, the splitter device 106 includes first and second signal outputs 108, 110 and a control port 112. As illustrated, one embodiment of the invention includes first and second preamplifier devices 114, 116. Preamplifier device 114 includes a signal input 109 and a signal output 118. Signal input 109 is coupled to signal output 108. Preamplifier device 116 includes a signal input 111 and a signal output 120. Signal input 111 is coupled to signal output 110.

Also included in the illustrated embodiment is a switching device 130. For simplicity of presentation, the switching device 130 is depicted schematically as a mechanical switching device. One of ordinary skill in the art will appreciate, however, that a wide variety of switching devices may be employed in various embodiments of the invention. For example, as an alternative to the mechanical switches shown, the switching device may include solid-state electronic switches, including bipolar junction transistor switches and field effect transistor switches, as well as optical switches, reed switches, other mechanical switches and combinations thereof. The switching device 130 includes first and second signal inputs 132, 134, first and second signal outputs 136, 138 and a control port 140.

A first tuner device 150 includes a signal input coupled to signal output 136 a signal output 152 and a control port 154. A second tuner device 156 includes a signal input coupled to signal output 138 a signal output 158 and a control port 160. According to one embodiment of the invention, at least one of the tuner devices 150, 156 includes a decoder such as, for example, an MPEG decoder, an MPEG-II decoder, or other decoder such as is known in the art.

The illustrated embodiment includes a video mixer 170 adapted to combine (for example in a PIP arrangement) first and second signals received from the first and second tuner devices 150, 156. In one embodiment of the invention, the video mixer 170 includes one or more decoder devices such as, for example an MPEG decoder device. The illustrated video mixer 170 includes a first signal input coupled to signal output 152 and a second signal input coupled to signal output 158. The video mixer 170 also includes at least one signal output 172.

In one embodiment of the invention, the tuner system 100 also includes an RF modulator device 180 with a first signal input coupled to signal output 172 and a second signal output 182. The second signal output 182 is coupled to an RF signal output node 184 of the signal tuning system 100. In one embodiment, the RF modulator device 180 includes an output buffer amplifier.

According to one embodiment of the invention, a further signal output node 186 of signal tuning system 100 is coupled to signal output 172 through, for example, a second output buffer amplifier 188. Also in the illustrated embodiment, the tuner system 100 includes a controller device 190.

The controller device 190 includes first, second, third and fourth control ports 192, 194, 196 and 197 coupled to control ports 112, 154, 160 and 140 respectively. In various embodiments, as would be understood by one of ordinary skill in the art, the control ports 192, 194, 196 and 197 are bidirectional control ports. In still other embodiments, one or more of the control ports 192, 194, 196 and 197 are unidirectional control ports. Where a control port is bidirectional, it may be implemented as a combination of two or more unidirectional control ports, bidirectional control ports, or combinations thereof. In one embodiment of the invention, an external power supply 198 is coupled to the tuner system 100 to supply power to the various components and devices of the tuner system.

In operation, the embodiment of the invention illustrated in FIG. 1 receives an RF signal including two separate information channels, such as television channels at input node 102 by way of terrestrial antenna 104. Under the control of the controller device 190, the two different channels are each directed through one or the other of two controllable signal paths. The controllable signal paths include at least the signal splitter, optionally the preamplifier devices 114, 116, the switching device 130, the tuning devices 150, 156 and the mixer device 170, as well as the various signal conductors that serve to couple these devices together. The controller optimizes the selection of signal paths based on one or more characteristics of the two signal paths, including performance of the signal paths and characteristics (e.g. signal strength, signal to noise ratio, MPEG data rate) of the incoming channel signals.

For example, in one embodiment of the invention, the splitter 106 is an asymmetrical splitter. Thus an output signal from signal output 108 of the splitter would exhibit a different average power level than at output signal from output 110 of the splitter.

In another embodiment of the invention, tuner 150 has better sensitivity than tuner 156. Thus the signal routed through tuner 150 would tend to have better quality at the output 152 of the tuner then a signal routed through tuner 156 to output 158.

In still another embodiment of the invention the characteristics of conductors disposed between the other signal path components makes one signal path better than the other. For example, the optimization of component layout may require that a geometric distance along one or more conductors between output 108 and the input 109 of preamplifier 114 be longer than a corresponding geometric distance along the one or more conductors between output 110 and the input 111 of preamplifier 116. In another embodiment, the differing layout of conductors and/or placement of components may result in differing capacitance and impedance characteristics between differing signal paths. This may also result in one signal path being better than another.

Accordingly the tuner system 100 illustrated in FIG. 1 receives a modulated RF signal at antenna 104. The RF signal includes information broadcast on a plurality of channels. For example, the RF signal may contain a first video signal and a second video signal. According to the illustrated embodiment, the RF signal including the first and second video signals is received at input 102 of splitter 106.

In one embodiment of the invention, the splitter is a symmetrical splitter, i.e., neglecting losses within the splitter, substantially all of the power applied to input 102 is evenly split between outputs 108 and 110. In another embodiment of the invention, the splitter is an asymmetrical splitter, where a larger proportion of the input power is provided to one output as compared to the power provided to the other output. For example output 108 might receive approximately three quarters of the power supplied to input 102, while output 110 receives approximately one quarter of the power supplied to input 102. Of course, one of skill in the art will appreciate that the selection of a three quarters to one quarter ratio is merely exemplary, and any ratio appropriate to the requirements of a particular application can be used in various embodiments of the invention.

As illustrated, the signal at output 108 of the signal splitter is received at the input of preamplifier 114. In like fashion, the signal at output 110 of the signal splitter is received at the input of preamplifier 116. Preamplifiers 114 and 116 serve to amplify the signals received at their respective inputs. The resulting amplified 5 signals are conducted from the outputs 118, 120 of preamplifiers 114, 116 to the corresponding inputs 132, 134 of switching device 130.

In various embodiments of the invention, the preamplifiers 114, 116 are omitted. In some circumstances, this will be desirable because such preamplifier devices may introduce distortion and signal noise, and may add cost to the resulting system. In other embodiments, as for example that shown in FIG. 1, the benefits of signal amplification outweigh these costs and the potential for distortion. In still another embodiment, the preamplifiers are incorporated within the tuners 150, 156.

According to the invention, controller 190 controls whether the output signal received at input 132, for example, is routed to the input of tuner device 150 or the input of tuner device 156. In the illustrated embodiment, the controller controls this routing of signals by applying a control signal to control port 140 of the switching device 130. Depending on the content of the control signal, the exemplary switching device is switched between a first state in which an output signal of preamplifier 114 is received at tuning device 156 and a second state in which the output of preamplifier 114 is received at tuning device 150.

In the FIG. 1 embodiment, the controller device 190 is shown as a discrete device or circuit. One of ordinary skill in the art will appreciate, however, that the functionality of the controller device 190 may be distributed among various devices including, for example, the tuner devices, the splitter devices, and other devices within the tuning system 100. In various embodiments, these devices may communicate on a master slave and/or a peer-to-peer basis to affect the requisite control function.

According to one embodiment of the invention, each of tuner devices 150, 156 is tunable under the control of controller device 190. Toward this end, the controller 190 can send and receive control signals between control port 194 and control port 154 and likewise between control port 196 and control port 160.

In various embodiments, the controller device 190 receives signals from one or more of the signal splitter device 106, tuner device 150, tuner device 156, switching device 130, and other signal sources such as would be understood by one of skill of the art. Based on the signals, and optionally based on other information such as preprogrammed parameters and values, the controller effects switching of the switching device 130.

In an exemplary embodiment, the mixer device 170 acts to direct an output signal from output 152 to a primary display region of a PIP display. The mixer device 170 also acts to direct an output signal from output 158 to a secondary (PIP) region of the PIP display.

For exemplary purposes, assume that the signal splitter device 106 is an asymmetrical signal splitter device. For example, the signal splitter device 106 may provide 30% of output signal power to output 108 and 70% of output signal power to output 110. Also assume that the tuner device 150 is a more accurate and/or sensitive tuner device than the tuner device 156.

During a first time interval, when both the primary and secondary incoming signal channels at input node 102 are relatively strong, the controller device 190 signals the switching device 130 to couple input 134 to output 136 and input 132 to output 138 (the state illustrated in FIG. 1). This directs the signal portion from output 108 to the input of tuner device 150 and the signal portion from output 110 to the input of tuner device 156.

At substantially the same time, the controller device 190 directs tuner 150 to tune to the channel to be displayed on the primary display region and further directs tuner 156 to tune to the channel to be displayed on the secondary display region. In this way, the better tuner device 150 supplying the main portion of the display receives a stronger input signal than the less good tuner device supplying the PIP portion of the display.

During a second time interval when both the primary and secondary incoming signal channels at input node 102 are relatively weak, the controller device 190 signals the switching device 130 to couple input 134 to output 138 and input 132 to output 136. This directs the signal portion from output 108 to the input of tuner device 150 and the signal portion from output 110 to the input of tuner device 156.

At substantially the same time, the controller device 190 directs tuner 150 to tune to the channel to be displayed on the primary display region and further directs tuner 156 to tune to the channel to be displayed on the secondary display region. In this way, the better performing tuner device 150 supplying the main portion of the display receives a weaker input signal than the lower performance tuner device supplying the PIP portion of the display.

The result is that the less good tuner device 156, which otherwise might have insufficient input power to properly detect the incoming signal, is able to tune and display the PIP portion of the display. This is particularly important in digital television transmission because, unlike analog transmission in which the PIP display might degrade relatively gracefully, a digital signal is likely to terminate abruptly as it crosses a threshold signal strength. Providing a stronger signal to the relatively lower performance tuner device 156, enables the tuning system 100 to provide adequate signals to both the primary display and the secondary (PIP) display. At the same time, the better tuning device 150 is likely to be capable of tuning the desired primary signal adequately from the less powerful signal portion supplied by output 108 of the splitter device.

As discussed above, whichever state the switching device is in, the mixer device 170 overlays the secondary PIP image on the primary image and outputs, for example, a baseband signal corresponding to the combined image. This baseband signal may be output through, for example, a buffer 188 to a baseband output 186 of the tuning system 100. The baseband signal may also be received into an RF modulator 180 and output as a modulated RF signal at output 184 of the tuner device 100.

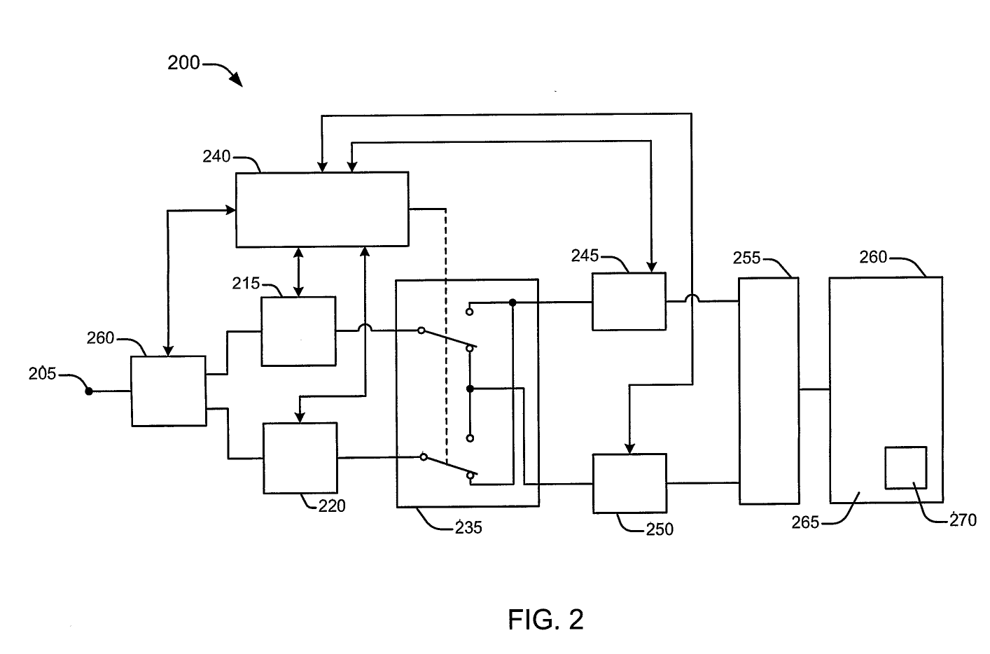

FIG. 2 shows, in block diagram form, a signal tuning device 200 according to a further embodiment of the invention. Like signal tuning device 100, described above, signal tuning device 200 includes first and second signal searchable paths. Unlike signal tuning device 100, the switching device of signal tuning device 200 is downstream of (i.e. coupled to respect and outputs of) first and second signal path tuning devices. The signal tuning device 200 is adapted to receive an RF signal (the “received signal”) at an input node 205. The signal received at node 205 is, in one embodiment, a carrier signal including a plurality of channels. In various embodiments, the received signal is received from an antenna, or a video device, including a video device capable of generating an RF signal, such as a DVD player, a video cassette recorder or a computer system, for example. In alternative embodiments, the received signal is generated by a combination of sources such as those named above. The present invention is not limited by the source of the received signal.

In one embodiment a signal splitter 260 has a signal input coupled to input node 205. As in the previously discussed embodiments, the signal splitter 260 may be a symmetrical signal splitter or an asymmetrical signal splitter.

In the illustrated embodiment, a first tuner device 215 and a second tuner device 220 are coupled to respective first and second signal outputs of the signal splitter 260. The first tuner device 215 is also referred to as the primary tuner. The second tuner device 220 is also referred to as the secondary tuner. In one embodiment of the invention, pre-amplifiers are coupled in the signal path within the tuner devices 215, 220.

In one embodiment of the invention, the first tuner 215 and second tuner 220 have different performance levels, performance characteristics, and costs associated with building each respective tuner. For example, in one embodiment, the first tuner 215 has a relatively higher performance level than the second tuner 220. As discussed above in relation to the FIG. 1 embodiment, the signal path coupled to the first and second tuners may have different performance levels as between the two signal paths.

A switching device 235 is coupled to respective signal outputs of the first tuner 215 and the second tuner 220. A controller 240 is coupled to respective control inputs of the first tuner 215, the second tuner 220, the switching device 235 and the signal splitter 260. A first decoder 245 and a second decoder 250 are coupled to respective signal outputs of the switching device 235.

The first decoder 245 is adapted to generate one video image signal based on the channel signal that it receives from the switching device 235. The second decoder 250 is adapted to generate a second video image signal based on the channel signal that it receives from the switching device 235.

A PIP mixer device 255 includes a first input coupled to a signal output of the first decoder 245 and a second input coupled to a signal output of the second decoder 250. A signal output of the PIP mixer device 255 is coupled to a signal input of a display screen 260. The display screen 260 is adapted to display, for example, a PIP video picture 270 within a main video picture 265.

In one embodiment of the invention, the controller 240 is adapted to control the splitter device 260. Accordingly, in one embodiment the controller receives a PIP on/off signal from, for example, a user of the system. In response to a “PIP off” state of this signal, the controller 240 deactivates the splitter 260 so that the incoming RF signal is not split, and only one tuner is active. In response to a “PIP on” state of the PIP on/off signal, the controller 240 activates the splitter 260 so that the incoming RF signal is split and both tuners are active.

In operation, the signal tuning device 200 receives the received signal at the input node 205. The received signal 205 carries a plurality of channels. If the PIP feature of the signal tuning device 200 is not in use, the controller 140 directs the signal to the first tuner 215. The first tuner 215 tunes to a channel to be displayed and outputs the tuned signal through the switching device 235 to the first decoder 245. The first decoder 245 generates a main picture with data in the tuned signal received from the first tuner 215.

If the PIP feature of the signal tuning device 200 is in use, the signal splitter 260 splits the signal 205 between the first tuner device 215 and the second tuner device 220. The tuner device 215 senses a first state of the received signal. In one embodiment the first state includes a reception characteristic of the signal. For example, in one embodiment, the controller 240 detects the relative signal strengths of a first channel bearing main image information and a second channel bearing PIP image information. According to one embodiment of the invention, the controller device receives respective signals from the first and second tuners 215, 220 and uses the signal to ascertain the relative signal strengths of the first channel and the second channel.

In another embodiment of the invention, the controller 240 adjusts a signal split ratio of the splitter 260 in response to, for example, a detected incoming signal strength and/or a further user input.

In response to the first state, the controller 240 directs the first tuner 215, which in this case has better signal sensitivity, to tune to the channel with the weaker signal and the second tuner 220 to tune to the channel having the stronger signal.

The controller 240 then sets the switching device 235 in response to the state of the received signal.

If the first tuner 215 is carrying the main channel, the controller 240 sets the switching device 235 to connect the first tuner 215 with the first decoder 245 and the second tuner 220 with the second decoder 250. Conversely, if the second tuner 220 is carrying the main channel, the controller 240 sets the switching device 235 to connect the second tuner 220 with the first decoder 245 and the first tuner 215 with the second decoder 250. In this way, a channel having a weak signal is provided to the better tuner, thus creating a better overall display at the PIP mixer 255.

In comparing the embodiments of FIGS. 1 and 2, one of skill in the art will appreciate that switching device 235 may, in various embodiments of the invention, be disposed at different possible points in the signal path. For example, the switching device 235 may have inputs coupled to respective outputs of the decoders 245, 250 rather than to the inputs thereof. In another embodiment of the invention, a single decoder is used, in multiplexed fashion (e.g., time multiplexed fashion), to process respective signals received from the first and second tuners.

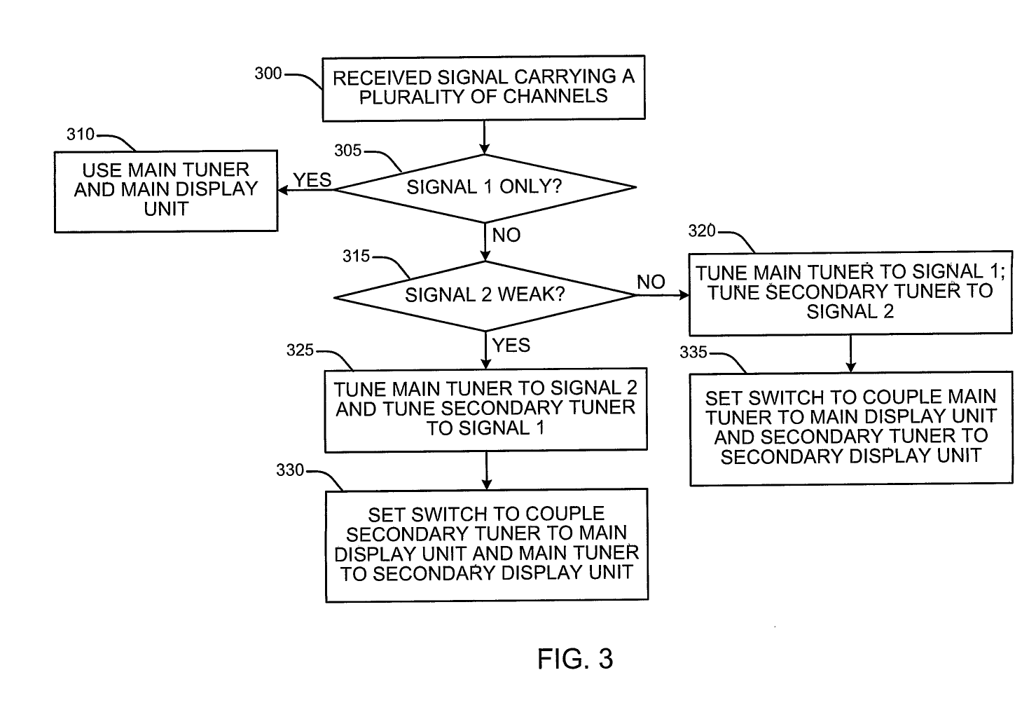

FIG. 3 shows, in flow diagram form, the operation 290 of a tuning system according to one embodiment of the invention. The controller controls a first tuner and a second tuner where the tuners have different operating characteristics. For example, the first tuner has better signal sensitivity than the second tuner. The controller further controls a first display unit that generates a main picture in a display screen and a second display unit that generates a PIP display in the display screen.

At step 300, the signal tuning device receives a signal carrying a plurality of channels. For the sake of simplicity, with regard to this figure, the portion of the received signal carrying a first channel is referred to as signal 1 and the portion of the received signal carrying a second channel is referred to as signal 2.

At step 305, the controller determines whether there is only a single channel to be displayed or whether more than one channel is to be displayed as a PIP system. If there is only a single channel to be displayed, the controller proceeds to step 310. If there is more than one channel to be displayed, the controller proceeds to step 315.

At step 310, the controller tunes the primary tuner to the channel to be displayed. The switching device is set to connect the primary tuner with the main display unit. When the PIP feature of the signal tuning device is turned off, the secondary tuner (as shown in FIG. 1) is not needed.

At step 315, the controller compares a signal characteristic of signal 1 versus a comparable characteristic of signal 2. For example, in one embodiment the controller compares the signal strength of signal 1 versus the signal strength of signal 2. In an alternative embodiment of the invention, the controller determines whether signal 2 is weak by comparing the strength of signal 2 with a threshold value. If signal 2 is not weaker than the threshold value, the controller proceeds to step 320. If signal 2 is weaker than the threshold value, the controller proceeds to step 325.

At step 320, the controller tunes the primary tuner to signal 1 and the secondary tuner to signal 2. Where signal 1 is substantially similar to or weaker than signal 2 (or where another parameter threshold is met), the primary tuner is used to carry the channel to be viewed as the main picture.

At step 335, the controller sets the switching device so that the primary tuner is coupled to the main display unit and the secondary tuner is coupled to the secondary display unit.

At step 325, the controller tunes the secondary tuner to signal 1 and the primary tuner to signal 2. Where signal 2 is weaker than signal 1 (or where another parameter threshold is met), the primary tuner is used to carry the channel to be viewed as the PIP.

At step 330, the controller sets the switching device so that the secondary tuner is coupled to the main video display unit and the primary tuner is coupled to the secondary display unit. In this way, the main channel displays in the main portion of the visual display and the PIP channel displays as a PIP display on the visual display.

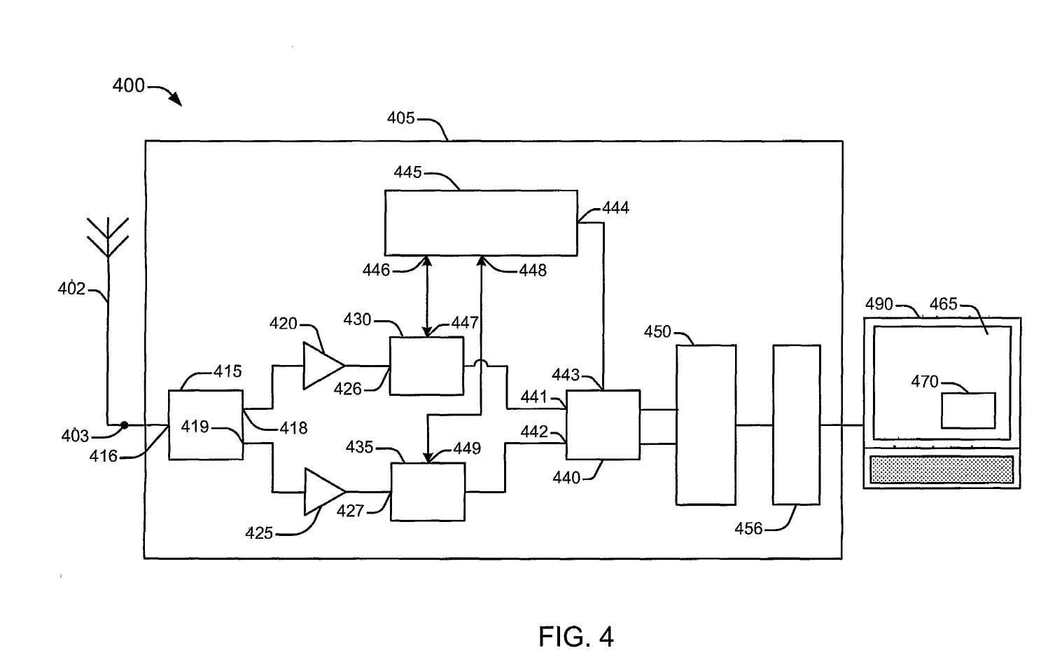

FIG. 4 is a block diagram of a signal tuning system 400 including a signal tuning device 405 according to a further embodiment of the invention. In the illustrated embodiment, the signal tuning system 400 receives signals from an antenna 402 at an input node 403. According to the illustrated embodiment, the received signal is an RF signal that includes a plurality of channels.

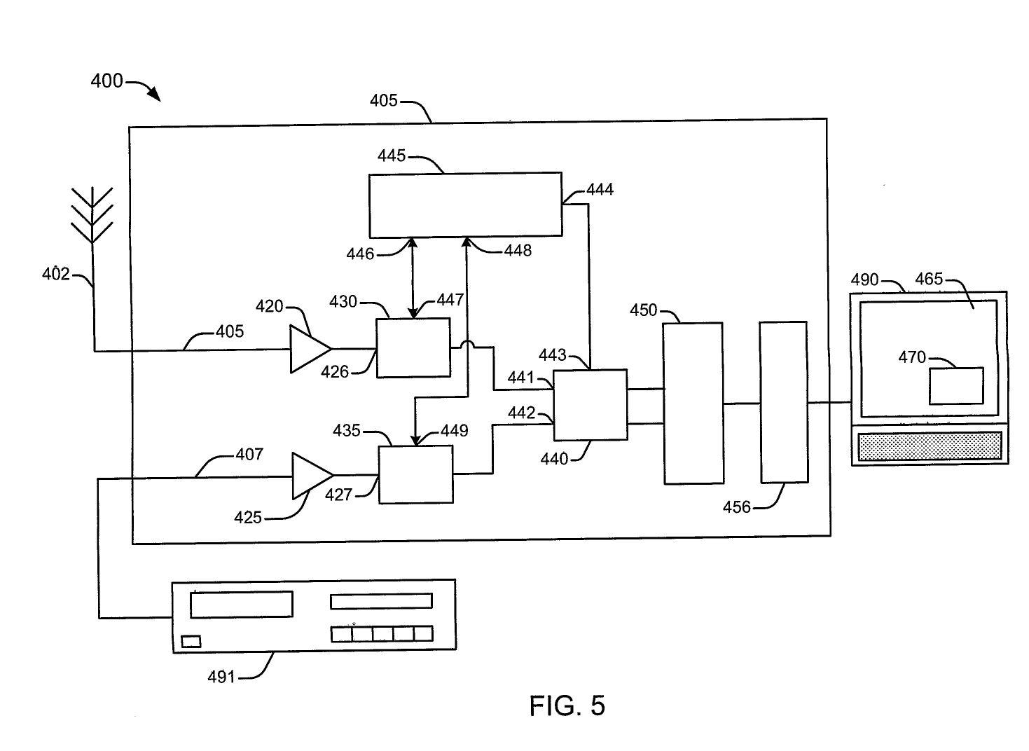

In various other embodiments, the signal tuning system 400 receives a plurality of signals from a single antenna, from multiple antennas, or from any other appropriate combination of other signal sources. For example, FIG. 5 shows a signal tuning system adapted to receive a first signal from a terrestrial antenna and a second signal from a second signal source such as, for example, a DVD player.

Referring again to FIG. 4, the tuning system 400 includes a signal splitter 415 with an input 416. The input 416 is coupled to receive a signal from the receiver input node 403. The signal splitter 415 also has first and second output nodes 418, 419. The first output node 418 is coupled to a corresponding input node of a first preamplifier 420. The second output node 419 is coupled to a corresponding input of a second preamplifier 425. An output of the first preamplifier 420 is coupled to a corresponding input 426 of a first tuning device 430. In like fashion, an output of the second preamplifier 425 is coupled to a corresponding input 427 of a second tuning device 435. One of skill in the art will appreciate that the preamplifiers 420, 425 may be discrete circuit portions, or may be incorporated within either one or both of the signal splitter 415 and the tuner devices 430, 435. For convenience, the first tuner device 430 may be referred to as the “primary tuner device” and the second tuner device 435 may be referred to as the “secondary tuner device.”

In one embodiment of the invention, the tuner devices 430, 435 have different characteristics from one another. For example, in one embodiment of the invention, the primary tuner device 430 may have better signal sensitivity than the secondary tuner device 435. In another embodiment, an overall signal path of the primary tuner device 430 may provide a processed signal having higher quality characteristics or precision in reproducing the broadcast signal than that of the second tuner device 435. This may reflect, for example, differences in the spatial length of the respective signal paths, capacitive and inductive characteristics of signal path elements including conductors and active and passive devices, the respective gains of the first 420 and second 425 preamplifiers, and various other signal path parameters, such as would be understood by one of skill in the art.

In the illustrated embodiment, the first and second tuner devices 430, 435 include respective decoder devices such as, for example, MPEG decoder devices. Accordingly, in contrast to the FIG. 1 and FIG. 2 embodiments, the FIG. 3 embodiment includes a switching device 440 that is disposed downstream of the decoder devices.

The switching device 440 has a first signal input 441 coupled to a corresponding output of the first tuner device 430 and a second signal input 442 coupled to a corresponding output of the second tuner device 435. The switching device 440 also has a control port 443. The control port 443 is coupled to a first control port of a controller 445, allowing the controller 445 to control a state of the switching device 440. The controller 445 has a second control port 446 coupled to a corresponding control port 447 of the first tuner device 430, and a third control port 448 coupled to a corresponding control port 449 of the second tuner device 435.

A video mixer device 450 is coupled to receive first and second output signals from the switching device 440 at respective inputs thereof. The video mixer device 450 processes the first and second signals to produce video data corresponding to a main display with a PIP display overlaid on a subregion of the main display, or disposed in a region proximate to the main display.

The video mixer device 450 has an output coupled to an input of an RF modulator device 456. An output of the RF modulator device is coupled to a display unit 490 including a display screen. The display screen of the display unit 490 is adapted to display a primary image, that, in one embodiment, substantially fills the display screen 465 along with a PIP image 470 that is overlaid on a portion of the primary image 465 on the display system 460.

In one embodiment, one or more of the tuner devices 430, 435 and the video mixer device 450 includes a respective data buffering device that is adapted to buffer signal data.

According to one embodiment of the invention, data is buffered and released through the one or more respective data buffering devices to provide a substantially uninterrupted stream of video data to the display unit 490. In one embodiment of the invention, this substantially prevents gaps and glitches that might otherwise be present in, for example, the displayed image due to switching of the switching device 440 and retuning of the tuners 430, 435. One of ordinary skill in the art will appreciate that the data buffering device may be a special-purpose device, may be a function of a general purpose device having other functions, or a combination thereof.

In a further embodiment, one or more of the tuner devices 430, 435 and the video mixer device 450 includes an error correction device that is adapted to correct an error in signal data. According to one embodiment of the invention, the data is corrected by the one or more respective error correcting devices to provide a substantially error-free stream of video data to the display unit 490.

In one embodiment of the invention, operation of the error correction device substantially prevents gaps and glitches that might otherwise be present in, for example, the displayed image due to defects in the available signal data, however introduced. One of skill in the art will appreciate that the error correction device may be, for example, a discrete device, a function of a general purpose device having other functions, or a combination thereof.

In operation, the signal tuning device 405 receives the received signal at the receiver 410. The received signal carries a plurality of channels.

If the PIP feature of the signal tuning device 100 is not in use, for example, disabled or not activated, the controller 445 directs the signal to the first tuner 430. The first tuner 430 tunes to a channel to be displayed and outputs the tuned signal through the switching device 440 to the first display unit 450. The first display unit 450 generates a main picture with data in the tuned signal received from the first tuner 430.

If the PIP feature of the signal tuning device 100 is in use, the signal splitter 415 splits the signal between the first amplifier 420 and the second amplifier 425. The amplifiers 420, 425 output the split signals to the tuners 430, 435. The signal tuning device 405 senses a first state of the received signal. For example, if the first state includes the reception characteristics of the signal, the relative signal strengths of a first channel to be viewed at the display system 460 versus a second channel to be viewed at the display system 460. In this discussion, the first channel is the channel to be viewed as the main display 465 filling the viewing area of the display screen 465 and the second channel is to be viewed as a PIP 470 inside the main display on the display system 460.

In response to the first state, the controller 445 directs the first tuner 430, which in this case has better signal sensitivity, to tune to the channel with the weaker signal and the second tuner 435 to tune to the channel having the stronger signal. The controller 445 then sets the switching device 440 in response to a second state of the received signal. In the present embodiment of the invention, the second state of the received signal is the information about which of the two channels is to be displayed in the main display and which is to be displayed in the PIP display. If the first tuner 430 is carrying the main channel, the controller 445 sets the switching device 440 to connect the first tuner 430 with the first display unit 450 and the second tuner 435 with the second display unit 455.

Conversely, if the second tuner 435 is carrying the main channel, the controller 445 sets the switching device 440 to connect the second tuner 435 with the first display unit 450 and the first tuner 430 with the second display unit 455. The display units 450, 455 generate display data for the main display 465 and PIP 470. The control mechanisms 452, 454 in the display units 450, 455 enable the display units 450, 455 to provide displays that are generally free from glitches caused by the switching device 460 when switching the tuners 430, 435.

FIG. 5 shows a tuning system according to one embodiment of the invention. The FIG. 5 embodiment is similar to that of FIG. 4 except that, as noted above, incoming signals are received from two or more discrete signal sources such as for example, a terrestrial antenna 402 and a video playback device such as a DVD player. In one embodiment, as illustrated, no signal splitter is used. Signals are received directly from first and second signal sources 402, 491 at respective inputs of first and second buffer amplifier devices 420, 425. In other respects, the tuning system embodiment 400 shown in FIG. 5 is comparable to the embodiment of FIG. 4, and components of the system are identified by the same reference numerals.

In a television system then, having a PIP feature and operating according to principles of the present invention, a channel having a weak signal is provided to a better tuner thus providing the highest possibility that the signal to be displayed for both the main display in the Pip display can be properly received.

It should again be noted that although the invention has been described with reference to specific video receiving equipment including PIP video receiving equipment, the invention has broader applicability and may be used in any video receiving equipment. Similarly, the process described above is but one method of many that could be used. The above description and drawings illustrate preferred embodiments which achieve the objects, features and advantages of the present invention. It is not intended that the present invention be limited to the illustrated embodiments. Any modification of the present invention which comes within the spirit and scope of the following claims should be considered part of the present invention.

1. An apparatus comprising:
a first tuner;
a second tuner; and
a controller adapted to tune said first and second tuners to respective first and second channel signals of a received signal responsive to a first signal state of said received signal and to tune said first and second tuners to said second and first channel signals respectively, responsive to a second signal state of said received signal.

2. The apparatus of claim 1 wherein said first signal state comprises a relatively weaker first channel signal, and said second signal state comprises a relatively stronger first channel signal, as compared to respective second channel signals.

3. The apparatus of claim 1 wherein said controller is adapted to compare said first and second channel signals to one another to determine which one of said first and second signal states said received signal occupies.

4. The apparatus of claim 1 further comprising:
a switching device, said switching device being adapted to signalingly couple an output of said first tuner to a first decoder and an output of said second tuner to a second decoder responsive to said received signal occupying said first signal state, said switching device being adapted to signalingly couple said output of said first tuner to said second decoder and said output of said second tuner to said first decoder responsive to said received signal occupying said second signal state.

5. A The apparatus of claim 4 further comprising a display screen, said display screen being adapted to substantially concurrently receive respective signals from said first and second decoders.

6. The apparatus of claim 5 wherein said display screen is adapted to display a first picture within a second picture, said first and second pictures being related to said respective signals from said first and second decoders.

7. The apparatus of claim 1 wherein said controller compares at least one of said first and second channel signals to a threshold value to determine which one of said first and second signal states said received signal occupies.

8. The apparatus of claim 1 wherein said first tuner includes a relatively better tuner and said second tuner includes a relatively worse tuner.

9. The apparatus of claim 1 further comprising an input buffer amplifier said input buffer amplifier being adapted to receive said received signal, said input buffer amplifier being adapted to couple said received signal to said first and second tuners.

10. The apparatus of claim 1 further comprising a preamplifier, said preamplifier having a signal output, said signal output being coupled to an input of one of said first and second tuners.

11. The apparatus of claim 1 wherein said controller is signalingly coupled to said input buffer amplifier and is adapted to detect said signal state of said received signal therefrom.

12. The apparatus of claim 1 wherein said controller is signalingly coupled to said splitter device and is adapted to detect said signal state of said received signal therefrom.

13. The apparatus of claim 1 wherein said controller is signalingly coupled to said first and second tuners and is adapted to detect said signal state of said received signal therefrom.

14. The apparatus of claim 1 wherein said controller is signalingly coupled to said first and second decoder devices and is adapted to detect said signal state of said received signal therefrom.

15. A method for prioritizing signals comprising the steps of:
receiving a received signal comprising a plurality of channels;
sensing a signal state of said received signal; and
tuning first and second tuners in response to the signal state, to respective channels of the plurality of channels.

16. A method as defined in claim 15 wherein said signal state relates to a signal strength of said received signal.

17. A method as defined in claim 16, further comprising comparing a signal strength of a first portion of said received signal to a strength of a second portion of said received signal.

18. A method as defined in claim 16, further comprising comparing a signal strength of a first portion of said received signal to a stored threshold value.

19. A method as defined in claim 18, wherein said stored threshold value comprises a permanently programmed value.

20. A method as defined in claim 16, wherein said stored threshold value comprises a dynamically calculated threshold value.
